(19) United States
(12) Patent Application Publication
(10) Pub. No.: US 2015/0070179 A1
(43) Pub. Date: Mar. 12, 2015

(54) WATERPROOFING DEVICE

(71) Applicants: Guowei Wu, Shenzhen (CN); Mingming Qiu, Shenzhen (CN)

(72) Inventors: Guowei Wu, Shenzhen (CN); Mingming Qiu, Shenzhen (CN)

(73) Assignee: ZTE CORPORATION, Nanshan District, Shenzen, Guangdong (CN)

(21) Appl. No.: 14/394,681

(22) PCT Filed: Jun. 5, 2012
(86) PCT No.: PCT/CN2012/076487

§ 371 Date: Nov. 25, 2014

(30) Foreign Application Priority Data
Apr. 16, 2012 (CN) 201210111440.5

(51) Int. Cl. G08B 21/20; G06F 1/26

(52) U.S. Cl. CPC G08B 21/20; G06F 1/26
USPC 340/603

(57) ABSTRACT

a waterproofing device for electronic equipment is provided, which includes: sensing unit, arranged in a shell of the electronic equipment and configured to output corresponding sensing signal when sensing that water permeates into the electronic equipment; and a powering-off unit, configured to generate a powering-off signal to power off the electronic equipment according to the sensing signal. In the invention, after water is sensed to permeate in the electronic equipment, power of a circuit board of the electronic equipment is immediately and automatically cut off, so that the problem of high short-circuiting rate of the circuit board after water permeates into the electronic equipment is solved, and an effect of avoiding loss is further achieved to a great extent.

### FIELD OF THE INVENTION

The invention relates to the field of electronic equipment, particularly to a waterproofing device for electronic equipment.

### BACKGROUND OF THE INVENTION

Along with the constant development of a mobile communication technology, various electronic equipment, for example, a mobile phone, has become an indispensable part in life. On the other hand, a rate of scrap of the mobile phone caused by the accidental permeation of water in the mobile phone is increasing. This is because water often permeates into the electronic equipment such as the mobile phone in daily life. Water permeation in the mobile phone in use will lead to the short-circuiting of a mainboard of the mobile phone, the mainboard of the mobile phone is often required to be replaced after being short-circuited, but cost in the replacement of the mainboard of the mobile phone is quite high. Thus it can be seen that the adoption of a waterproofing measure for the mobile phone can avoid loss to a great extent.

At present, a mechanical waterproofing mode is adopted for most of waterproof mobile phones, namely a shell is made from an advanced nanometer material to prevent the permeation of water; however, the mechanical waterproofing mode has shortcomings as follows: 1, the material cost is high, and a manufacturing process is complex; and 2, the mobile phone can be mechanically abraded after being used for a long time, so that the waterproofing performance of the material is greatly lowered.

### SUMMARY OF THE INVENTION

The invention provides a waterproofing device for electronic equipment, so as to at least solve the problem of high short-circuiting rate of a circuit board after water permeates into the electronic equipment.

According to an embodiment of the invention, a waterproofing device is provided, which is applied to electronic equipment and includes: sensing unit, arranged in a shell of the electronic equipment and configured to output corresponding sensing signal when sensing that water permeates into the electronic equipment; and a powering-off unit, configured to generate a powering-off signal to power off the electronic equipment according to the sensing signal.

Preferably, the sensing unit is pressure sensor, and the sensing signal is pressure signal converted from pressure generated when the pressure sensor senses that water permeates into the electronic equipment.

Preferably, the powering-off unit is a power-off triggering circuit, and an input end of the powering-off unit is connected with output end of the pressure sensor, triggers the powering-off signal in response to the input pressure signal, and outputs the powering-off signal to a power circuit of the electronic equipment to power off the electronic equipment.

Preferably, the pressure sensor is fiber grating pressure sensor.

Preferably, the type of the pressure sensor is at least one of: a resistive sensor, a resistance strain sensor, a piezoresistive sensor, a capacitive sensor and a resonant sensor.

Preferably, there is a plurality of pressure sensors, and the plurality of pressure sensors are arranged at multiple gaps of the shell of the electronic equipment respectively.

Preferably, there is a plurality of pressure sensors, arranged on a peripheral edge of a circuit board of the electronic equipment respectively.

Preferably, the pluralities of pressure sensors are welded on the circuit board of the electronic equipment in a Surface Mount Technology (SMT) way respectively.

Preferably, the device further includes a setting unit, wherein the setting unit is configured to preset the number of reference pressure sensors; the powering-off unit further includes a judgment logic circuit, configured to judge the number of the received sensing signals and allow the powering-off unit to generate the powering-off signal only when the number of the received sensing signals is more than or equal to the preset number of the reference pressure sensors.

Preferably, the electronic equipment is a mobile terminal.

In the invention, after water is sensed to permeate in the electronic equipment, power of the circuit board of the electronic equipment is immediately and automatically cut off, so that the problem of high short-circuiting rate of the circuit board after water permeates into the electronic equipment is solved, and an effect of avoiding loss is further achieved to a great extent.

### BRIEF DESCRIPTION OF THE DRAWINGS

The drawings are described here to provide further understanding of the invention, and form a part of the invention. The schematic embodiments and description of the invention are adopted to explain the invention, and do not form improper limits to the invention. In the drawings:

FIG. 1 is a structure diagram of a waterproofing device for electronic equipment according to an embodiment of the invention;

FIG. 2 is a structure diagram of a mobile phone with a waterproofing effect according to embodiment 1 of the invention;

FIG. 3 is a schematic diagram of positions of pressure sensors in a mobile phone according to embodiment 1; and

FIG. 4 is a structure diagram of a pressure sensor according to embodiment 1.

### DETAILED DESCRIPTION OF THE EMBODIMENTS

The invention is described below with reference to the drawings and embodiments in detail. It is important to note that the embodiments of the invention and the characteristics in the embodiments can be combined under the condition of no conflicts.

FIG. 1 is a structure diagram of a waterproofing device for electronic equipment according to an embodiment of the invention. As shown in FIG. 1, the waterproofing device includes: sensing units 10, arranged in a shell of the electronic equipment and configured to output corresponding sensing signals when sensing that water permeates into the electronic equipment; and a powering-off unit 20, configured to generate a powering-off signal to power off the electronic equipment according to the sensing signals.

In the embodiment, after water is sensed to permeate in the electronic equipment, power of a mainboard of the electronic equipment is immediately and automatically cut off, so that the problem of high short-circuiting rate of a circuit board after water permeates into the electronic equipment is solved, and an effect of avoiding loss is further achieved to a great extent.

In the above-mentioned embodiment, the electronic equipment is a mobile phone, and the waterproofing device can be applied to a mobile phone adopting any operating system. The sensing units can be implemented by pressure sensors, and the powering-off unit can be implemented by a circuit (called a power-off triggering unit below) which triggers the powering-off signal according to the signals of the pressure sensors. The powering-off signal can be output to a power circuit of the mobile phone, thereby automatically powering off the circuit board of the mobile phone.

Wherein, the pressure sensors can be selected from resistive sensors, resistance strain sensors, piezoresistive sensors, capacitive sensors, resonant sensors and the like.

The pressure sensors can be arranged around an edge of the circuit board of the mobile phone, and after water accidentally permeates into the mobile phone of a user, the pressure sensors arranged at four positions on the edge of the circuit board of the mobile phone generate the pressure signals due to the permeation of water. Wherein, when voltage or frequency signals output by the pressure sensors are transmitted to the power-off triggering unit, the power-off triggering unit transmits the powering-off signal to the power circuit. After the power circuit receives the powering-off signal, the circuit is automatically powered off, so that an aim of protecting a mainboard circuit of the mobile phone is fulfilled.

In addition, the mobile phone can further include an input unit and a control unit. A triggering condition of the power-off triggering unit is set by virtue of the input unit and the control unit. For example, when the four pressure sensors are arranged at four positions of the mobile phone, the number of the pressure sensors which act can be set to be 2 by virtue of the input unit, and only when the pressure sensors at two positions transmit the signals, the triggering unit triggers the power-off of the circuit board. Of course, the number of the pressure sensors which act can also be set to be 0 (namely a waterproofing function is disabled). In this case, the number of valid pressure sensors can be flexibly set for different environments, so that the practicability of the waterproofing device is greatly improved.

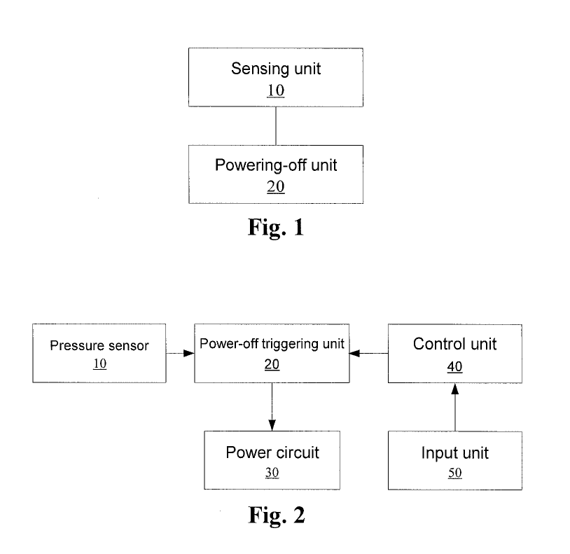

FIG. 2 is a structure diagram of a mobile phone with a waterproofing effect according to embodiment 1 of the invention. As shown in FIG. 2, the mobile phone includes: pressure sensors 10, a power-off triggering unit 20, a mobile phone power circuit 30, a control unit 40 and an input unit 50.

Wherein, output ends of the pressure sensors 10 are connected with an input end of the power-off triggering unit 20, an output end of the power-off triggering unit 20 is connected with the mobile phone power circuit 30, an output end of the input unit 50 is connected with an input end of the control unit 40, and an output end of the control unit 40 is connected with the input end of the power-off triggering unit 20.

In the above-mentioned embodiment, a working flow of each functional module is as follows: when water accidentally permeates into the mobile phone, the pressure sensors 10 arranged in the mobile phone generate signals, and output voltages or frequencies to the power-off triggering unit 20, the power-off triggering unit 20 transmits a powering-off signal to the mobile phone power circuit 30 if a powering-off condition is met after receiving the voltages or frequencies output by the pressure sensors 10, and the mobile phone power circuit 30, after receiving the powering-off signal, immediately powers off the mobile phone.

The input unit 55 and the control unit 40 can set the triggering condition of the power-off triggering unit 20, for example, the triggering condition can be set to be that the mobile phone is powered off only when two and more than two sensors transmit the signals under conditions of dryness and farness away from a water source, so as to prevent the misinformation of the sensors. Or the triggering condition is eliminated, namely a waterproofing function is disabled. Under conditions of wetness and closeness to the water source, the triggering condition can be set to be that the power-off triggering unit 20 fulfills a powering-off aim as long as one sensor transmits the pressure signal.

A setting process is as follows: different triggering conditions of the power-off triggering unit 20 are set according to different environments, the input unit 50 inputs the conditions, and transmits the conditions to the control unit 40, and the control unit 40 writes the set conditions into the power-off triggering unit 20, namely the powering-off aim can be fulfilled only when the triggering conditions are met.

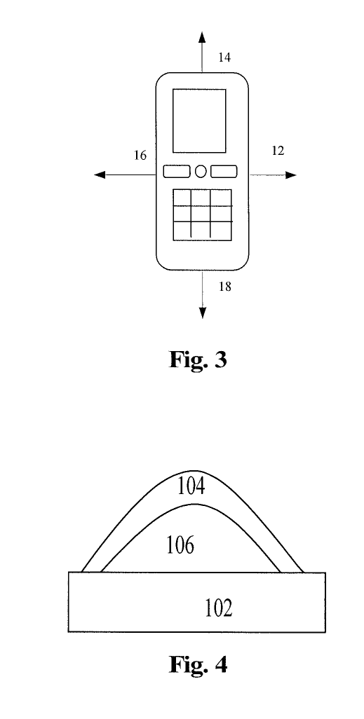

FIG. 3 is a diagram of positions of pressure sensors according to embodiment 1. As shown in FIG. 3, under the condition that water accidentally permeates into a mobile phone or is condensed into water drops in a humid environment, the pressure sensors (12, 14, 16, 18) can be arranged at four positions on an inner periphery of a shell of the mobile phone respectively. The four positions are generally in the vicinity of an interface or a hole in a structure of the mobile phone, such as an earphone jack, a Universal Serial Bus (USB) interface, a volume button and a power button, in which water can easily permeate, so that water permeation at different angles can be first detected.

The pressure sensors 10 and the power-off triggering unit 20 adopt wired connection, the sensors 10 are placed on an edge of a circuit board or a border of the shell, and can also be directly welded on the circuit board in an SMT way, and by the SMT way, a jump wire can be avoided, and simplicity in manufacturing can be ensured.

FIG. 4 is a structure diagram of a pressure sensor according to embodiment 1. According to the embodiment, a fiber grating sensor is adopted for sensing the permeation of water in a mobile phone. Since the fiber grating sensor has the characteristics of high measurement accuracy, high long-term stability, wide application range and the like, the sensor adopted in the embodiment is a high-accuracy fiber grating micro-sensor.

As shown in FIG. 4, the fiber grating sensor includes: a substrate 102, an elastic sheet 104 and a fiber grating 106, wherein the elastic sheet 104 is rigidly fixed together with the fiber grating 106; a central part of the fiber grating 106 is fixed together with the substrate 102; and the other part of the fiber grating 106, the elastic sheet 104 and the substrate 102 are closely combined.

When pressure acts on the elastic sheet 104, the elastic sheet is deformed, so that the fiber grating 106 is deformed to cause a wavelength change of the fiber grating; and the magnitude of the pressure can be obtained by calculating the wavelength change.

Wherein, the substrate 102 adopts a rigid sheet, and a data wire is arranged in the substrate 102, and is used for transmitting a pressure signal generated by the fiber grating 106. The fiber grating 106 adopts a Fiber Bragg Grating (FBG), and the FBG performs measurement by utilizing a change in a wavelength signal, and has the advantages of safety, anti-electromagnetic interference property, corrosion resistance, long transmission distance, small size, light weight and the like.

In addition, during practical application, various pressure sensors such as a resistive sensor, a resistance strain sensor, a piezoresistive sensor, a capacitive sensor and a resonant sensor can also be used.

From the description above, it can be seen that the invention achieves the following technical effects that:
when water permeates into the mobile phone, the permeation of water is sensed by the pressure sensors, and the triggered powering-off signal is output to the power circuit to rapidly power off the circuit board so as to fulfill the aim of preventing the circuit board from being short-circuited. Meanwhile, the switching-on and switching-off of the waterproofing circuit and the number of the sensors which act can be flexibly controlled, and a waterproofing protection aim is effectively fulfilled for different environments.

Obviously, those skilled in the art should know that each module or step of the invention can be implemented by a universal computing device, and the modules or steps can be concentrated on a single computing device or distributed on a network formed by a plurality of computing devices, and can optionally be implemented by programmable codes executable for the computing devices, so that the modules or steps can be stored in a storage device for execution with the computing devices, or can form each integrated circuit module, or multiple modules or steps therein can form a single integrated circuit module for implementation. As a consequence, the invention is not limited to any specific hardware and software combination.

The above is only the preferred embodiment of the invention and not intended to limit the invention, and for those skilled in the art, the invention can have various modifications and variations. Any modifications, equivalent replacements, improvements and the like within the spirit and principle of the invention shall fall within the scope of protection of the invention.

1. A waterproofing device, applied to electronic equipment and comprising:
sensing unit, arranged in a shell of the electronic equipment and configured to output corresponding sensing signal when sensing that water permeates into the electronic equipment; and
a powering-off unit, configured to generate a powering-off signal to power off the electronic equipment according to the sensing signals.

2. The device according to claim 1, wherein the sensing unit is pressure sensor, and the sensing signal is pressure signal converted from pressure generated when the pressure sensor senses that water permeates into the electronic equipment.

3. The device according to claim 2, wherein the powering-off unit is a power-off triggering circuit, and an input end of the powering-off unit is connected with output end of the pressure sensor, triggers the powering-off signal in response to the input pressure signal, and outputs the powering-off signal to a power circuit of the electronic equipment to power off the electronic equipment.

4. The device according to claim 3, wherein the pressure sensor is fiber grating pressure sensor.

5. The device according to claim 3, wherein the type of the pressure sensor is at least one of:
a resistive sensor, a resistance strain sensor, a piezoresistive sensor, a capacitive sensor and a resonant sensor.

6. The device according to claim 5, wherein there is a plurality of pressure sensors, and the plurality of pressure sensors are arranged at multiple gaps of the shell of the electronic equipment respectively.

7. The device according to claim 5, wherein there is a plurality of pressure sensors, and the plurality of pressure sensors are arranged on a peripheral edge of a circuit board of the electronic equipment respectively.

8. The device according to claim 7, wherein the plurality of pressure sensors are welded on the circuit board of the electronic equipment in a Surface Mount Technology (SMT) way respectively.

9. The device according to claim 7, further comprising a setting unit, wherein
the setting unit is configured to preset the number of reference pressure sensors; and
the powering-off unit further comprises a judgment logic circuit, configured to judge the number of the received sensing signals and allow the powering-off unit to generate the powering-off signal only when the number of the received sensing signals is more than or equal to the preset number of the reference pressure sensors.

10. The device according to claim 1, wherein the electronic equipment is a mobile terminal.

11. The device according to claim 2, wherein the electronic equipment is a mobile terminal.

12. The device according to claim 3, wherein the electronic equipment is a mobile terminal.

13. The device according to claim 4, wherein the electronic equipment is a mobile terminal.

14. The device according to claim 5, wherein the electronic equipment is a mobile terminal.

15. The device according to claim 6, wherein the electronic equipment is a mobile terminal.

16. The device according to claim 7, wherein the electronic equipment is a mobile terminal.

17. The device according to claim 8, wherein the electronic equipment is a mobile terminal.

18. The device according to claim 9, wherein the electronic equipment is a mobile terminal.
